(19) United States
(12) Patent Application Publication
(10) Pub. No.: US 2007/0277454 A1
(43) Pub. Date: Dec. 6, 2007

(54) Window system

(76) Inventor: Neil K. Box, Dickinson, TX (US)

Correspondence Address: HARSHAW RESEARCH, INC., 210 W. TECUMSEH STREET, OTTAWA, KS, 66067, US

(21) Appl. No.: 11/444,046

(22) Filed: May 31, 2006

(51) Int. Cl. E06B 1/04

(52) U.S. Cl. 52/204.1

(57) ABSTRACT

A window system according to the present invention includes an outer frame, a stationary inner frame, and a movable inner frame. The outer frame defines channels extending substantially between first and second ends thereof. Protrusions on the movable frame may extend into these channels for moving the movable frame between the first and second outer frame ends. Inclined portions of the channels allow the movable frame to move into a position collinear with the stationary frame. Compressible seals are positioned keep air from passing between the three frame portions at this collinear “closed window” configuration. A sensor may be integrated in the outer frame for detecting a breach in the stationary or movable frame.

### BACKGROUND OF THE INVENTION

This invention relates generally to windows and, more particularly, to a pre-hung window system incorporating a track with compressible seals that forms a complete seal from outside air and intrusions.

Windows seal against air leakage as well as from intrusions, e.g. air, dust, rain, insects, and the like. Window systems, of course, typically have a gap between the frame and the window in order to function properly, e.g. to open and close, tilt for cleaning, or to account for building movement. Unfortunately, these gaps can lead to leaking of energy such as air conditioning and heating.

Various devices have been proposed in the art for improving the efficiency of window systems. Although assumably effective for their intended purposes, the existing products and proposals do not efficiently form a complete seal and do not include enhanced features for security.

Therefore, it would be desirable to have a window system for selectively sealing against air and moisture leakage and other outside intrusions. It would also be desirable to have a window system having tracks and compressible seals for efficiently sealing and unsealing the window. Further, it would be desirable to have a window system with integrated security sensors.

### SUMMARY OF THE INVENTION

Accordingly, a window system according to the present invention includes an outer frame, a stationary inner frame, and a movable inner frame. The stationary frame includes protrusions that may extend into complementary holes in the outer frame for coupling these frame elements together. Similar protrusions on the movable frame may extend into channels defined by the outer frame for moving the movable frame between first and second ends of the outer frame. Inclined portions of the channels allow the movable frame to move into a position collinear with the stationary frame (a “closed window” configuration). Compressible seals are positioned keep air from passing between the three frame portions at this collinear configuration. A sensor, such as a glass break sensor, is integrated in the outer frame for detecting a breach in the stationary or movable frame.

Therefore, a general object of this invention is to provide a window system for selectively and efficiently sealing a window from intrusions or leakage.

Another object of this invention is to provide a window system, as aforesaid, having a window frame that is movable between sealed and unsealed configurations.

Still another object of this invention is to provide a window system, as aforesaid, having channels with inclined portions and having seals strategically positioned such that the frames are sealed when protrusions on the movable frame move along the inclined channel portions.

Yet another object of this invention is to provide a window system, as aforesaid, which includes a security sensor for detecting a breach in the stationary or movable frames.

A further object of this invention is to provide a window system, as aforesaid, that is easy to operate.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a window system according to a preferred embodiment of the present invention;

FIG. 2a is a front view of the stationary frame as in FIG. 1;

FIG. 2b is a sectional view taken along line 2b-2b as in FIG. 2a;

FIG. 3a is a front view of the movable frame as in FIG. 1;

FIG. 3b is a sectional view taken along line 3b-3b as in FIG. 3a;

FIG. 4a is a front view of the window system as in FIG. 1;

FIG. 4b is a sectional view taken along line 4b-4b as in FIG. 4a in a closed configuration;

FIG. 4c is a sectional view taken along line 4b-4b as in FIG. 4a in an open configuration;

FIG. 5a is a front view of the outer frame as in FIG. 1;

FIG. 5b is a sectional view taken along line 5b-5b of FIG. 5a;

FIG. 5c is an isolated view on an enlarged scale taken from FIG. 5a;

FIG. 5d is an isolated view on an enlarged scale taken from FIG. 5b;

FIG. 6a is a front view of a seal that extends about the inner frame shown in FIG. 5d;

FIG. 6b is a sectional view taken along line 6b-6b of FIG. 6a;

FIG. 6c is an isolated view on an enlarged scale taken from FIG. 6b;

FIG. 7a is a front view of a seal as in FIG. 6a having a different configuration;

FIG. 7b is a sectional view taken along line 7b-7b of FIG. 7a;

FIG. 7c is an isolated view on an enlarged scale taken from FIG. 7b;

FIG. 8a is a window system according to another embodiment of the present invention; and

FIG. 8b is a sectional view taken along line 8b-8b of FIG. 8a.

### DESCRIPTION OF THE PREFERRED EMBODIMENT

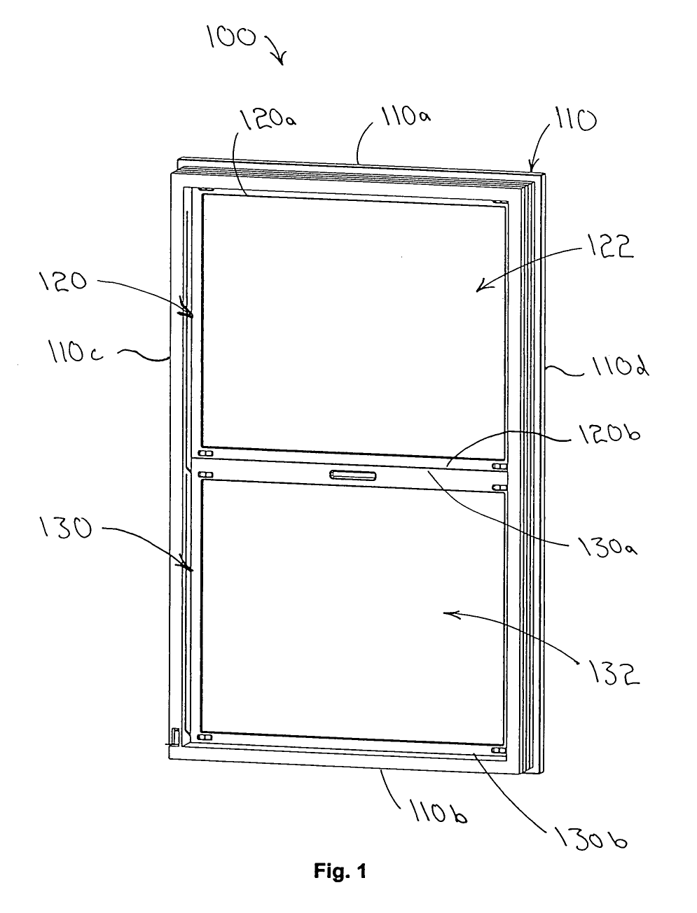

A window system 100 according to the present invention will now be described in detail with reference to FIGS. 1 through 8b of the accompanying drawings. More particularly, a window system 100 according to the current invention includes an outer frame 110, a stationary inner frame 120, and a movable inner frame 130.

The outer frame 110 has opposed first and second ends 110a, 110b which may be referred to herein as top and bottom ends 110a, 110b. It should be understood that the terms “top” and “bottom” are only used for convenience, however, as the outer frame 110 may be installed with ends 110a, 110b reversed or as left or right sides. The outer frame also has opposed third and fourth sides 110c, 110d that are generally perpendicular to the first and second ends 110a, 110b, as shown in FIG. 1. The outer frame 110 may be constructed of metal, wood, plastic, composite, or another suitable material.

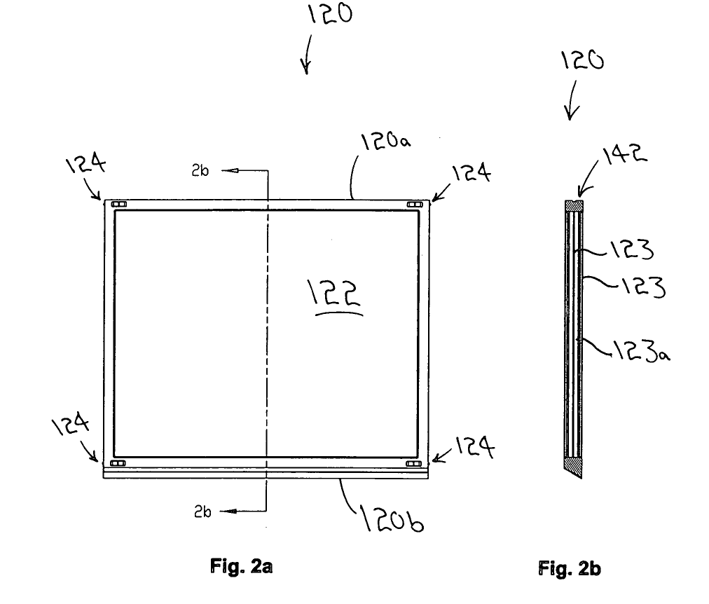

The stationary inner frame 120 is inside the outer frame 110 at the outer frame first end 110a. The stationary frame 120 has opposed first and second ends 120a, 120b which may be referred to herein as top and bottom ends 120a, 120b. Again, it should be understood that the terms “top” and “bottom” are only used for convenience, as the position of the first and second ends 120a, 120b depends on the installation of the outer frame 110. The stationary inner frame 120 may be fixedly or removably attached to the outer frame 110, and the stationary frame 120 may have a transparent section 122 (FIGS. 2a and 2b) which may include one or more pane 123 of glass or composite, for example. If more than one pane 123 is present, the panes 123 may be separated by an insulator 123a, such as a gaseous substance (FIG. 2b).

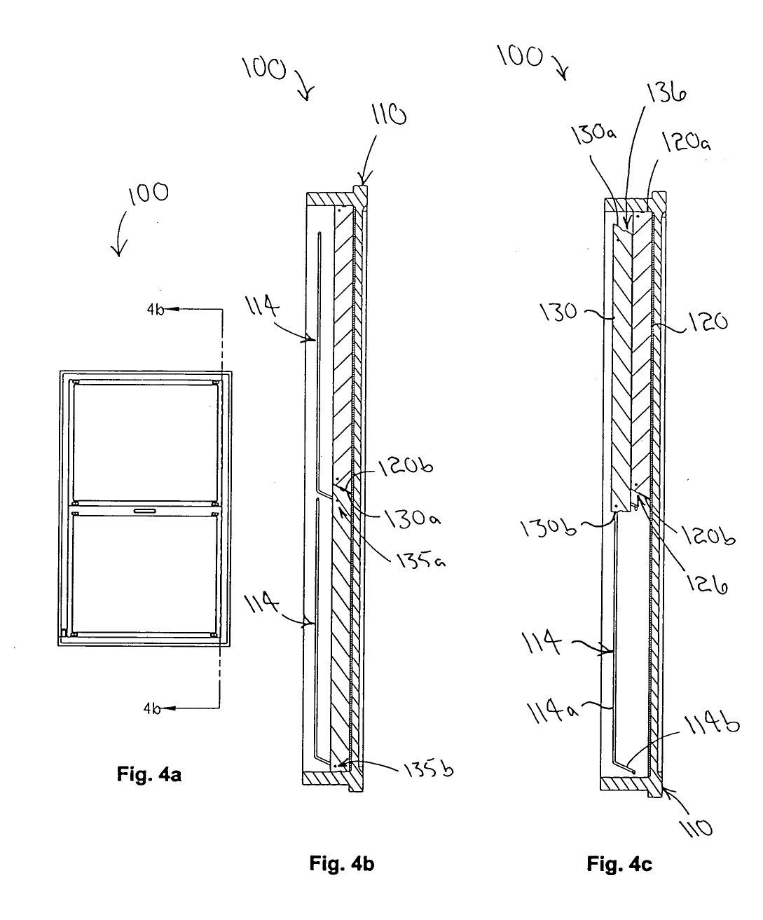

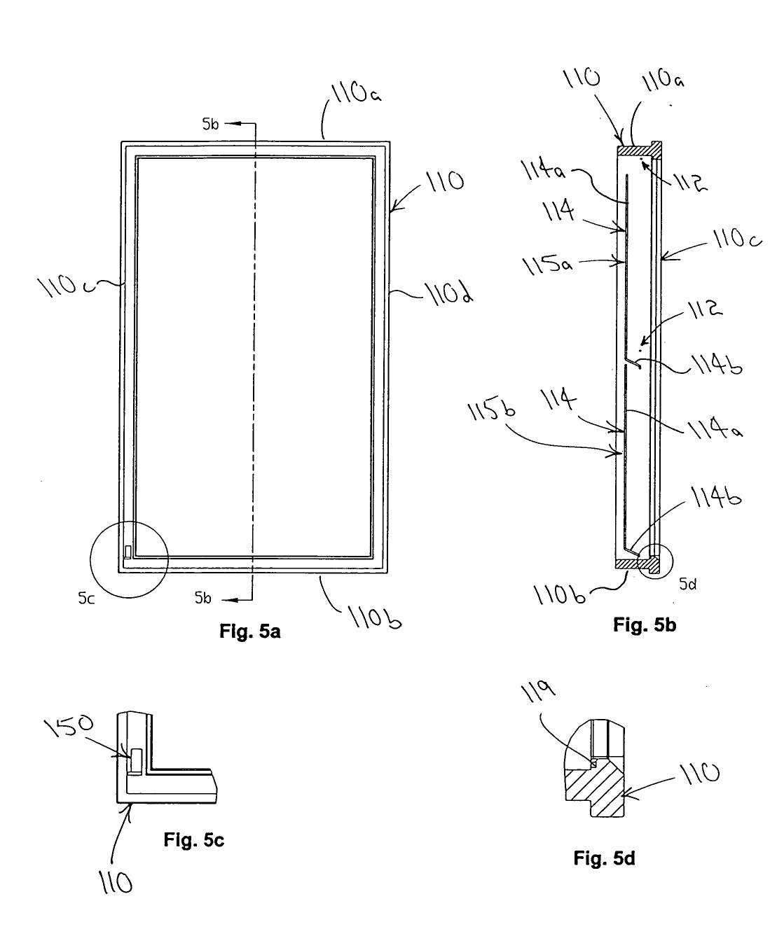

To removably attach the stationary frame 120 to the outer frame 110, the third and fourth sides 110c, 110d of the outer frame 110 may collectively define one or more pairs of opposed holes 112 (FIG. 5b), and one or more pairs of protrusions 124 (FIGS. 4b and 4c) complementary to the holes 112 may extend from the stationary frame 120. The protrusions 124 may selectively extend into the holes 112 to couple the stationary frame 120 to the outer frame 110.

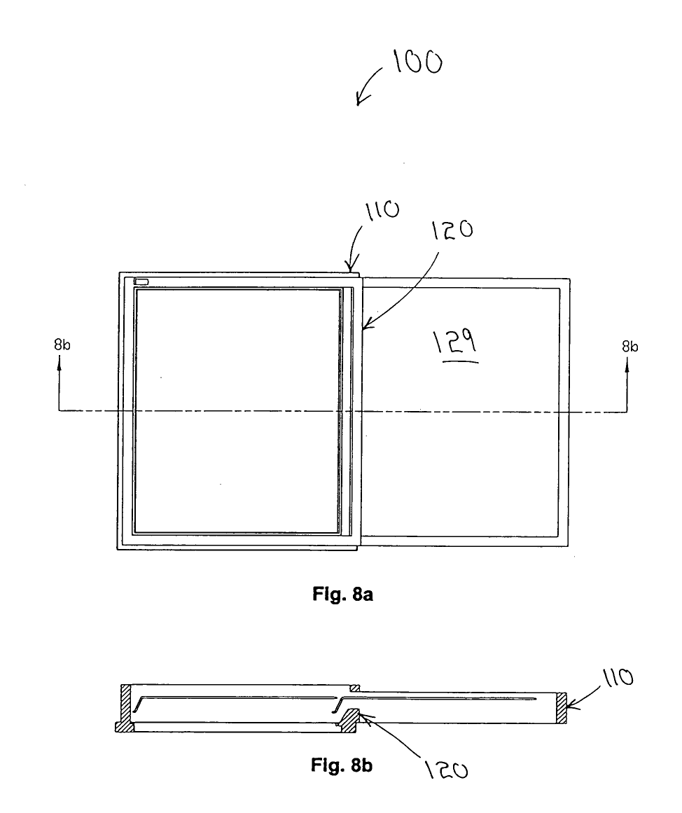

The stationary frame 120 may alternately be fixedly attached to the outer frame 110, and as shown in FIGS. 8a and 8b, the stationary frame 120 may have an open section 129. In the embodiment shown in FIGS. 8a and 8b, the stationary frame 120 is essentially a crossbar spanning the width of the outer frame 110. It is intended that the outer frame 110 according to this embodiment be installed in a wall so that the open section 129 of the stationary frame 120 is inside the wall, though other installation methods may be possible.

The movable inner frame 130 is positionable in the outer frame 110 for movement between the outer frame second end 110b and the outer frame first end 110a. The movable frame 130 has opposed first and second ends 130a, 130b which may be referred to herein as top and bottom ends 130a, 130b. Again, it should be understood that the terms “top” and “bottom” are only used for convenience, as the position of the first and second ends 130a, 130b depends on the installation of the outer frame 110. When the movable frame 130 is at the outer frame second end 110b, the movable frame top end 130a is adjacent the stationary frame bottom end 120b so that the movable frame 130 and the stationary frame 120 are colinear (FIG. 4b). This is the closed configuration. When the movable frame 130 is at the outer frame first end 110a, the movable frame 130 and the stationary frame 120 are generally parallel (FIG. 4c). This is the “open” configuration. As shown in FIGS. 4b and 4c, the stationary frame bottom end 120b may have a depth 126 that is angled relative to the horizon, and the movable frame top end 130a may have a depth 136 that is angled complementary to the angled depth 136 of the stationary frame bottom end 120b.

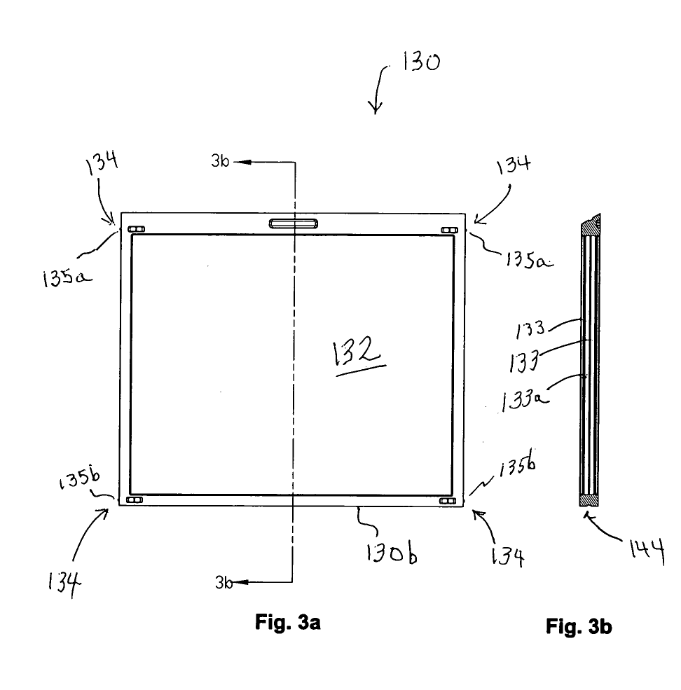

The movable frame 130 may have a transparent section 132 (FIGS. 3a and 3b) which may include one or more pane 133 of glass or composite, for example. If more than one pane 133 is present, the panes 133 may be separated by an insulator 133a, such as a gaseous substance (FIG. 3b).

To make the movable frame 130 movable between the first and second ends 110a, 110b of the outer frame 110 as described above, the third and fourth sides 110c, 110d of the outer frame 110 may collectively define first and second pairs 115a, 115b of opposed channels 114 having a longitudinal portion 114a and an inclined portion 114b (FIG. 5b), and first and second pairs 135a, 135b of protrusions 134 complementary to the channels 114 may extend from the movable frame 130 (FIGS. 4b and 4c). The longitudinal portions 114a of the first pair 115a of opposed channels 114 may be colinear with the longitudinal portions 114a of the second pair 115b of opposed channels 114. The protrusions 134 may extend into the channels 114 to couple the movable frame 130 to the outer frame 110, and the protrusions 134 may be movable in the first pair of channels 114 to allow the movable frame 130 to move between the first and second ends 110a, 110b of the outer frame 110. At least one protrusion 134 may be extendable to lock the movable frame 130 at a position in the outer frame 110.

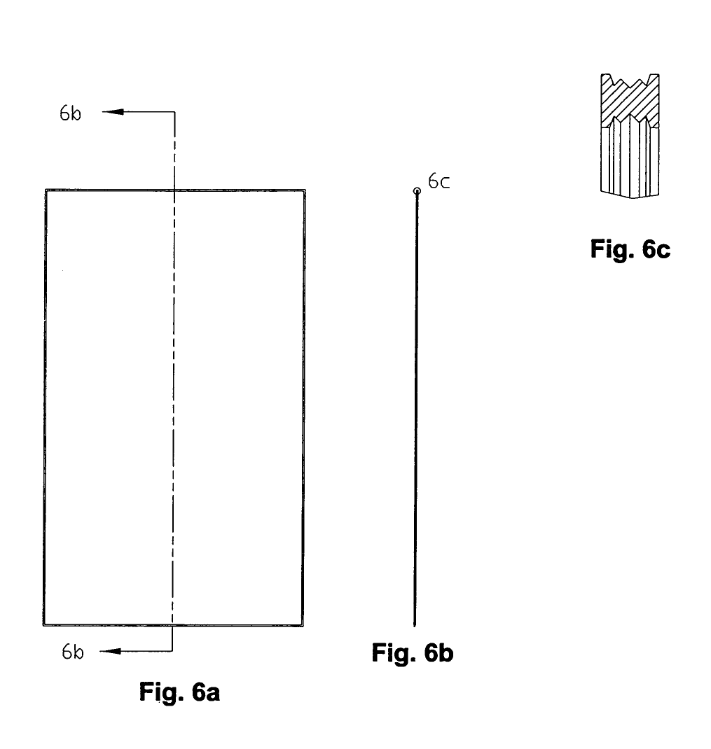

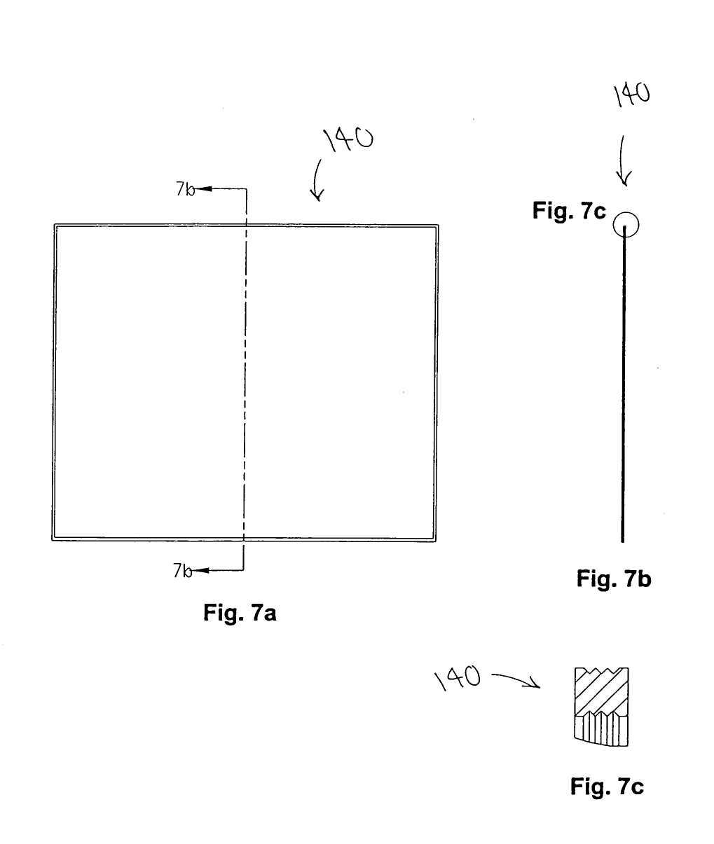

A seal 140 (FIGS. 6a through 6c) may extend along an inner edge 119 of the inner frame 110 (FIG. 5d) for interaction with the movable frame 130 when the movable frame is at the outer frame bottom end 110b and for interaction with the stationary frame 120 at the outer frame top end 110a. The seal 140 may be a compression seal, as shown in FIGS. 6a through 6c. FIGS. 7a through 7c show that the seal 140 may be shaped differently, depending on the shape of the outer frame 110. A seal 142 may extend across or around the stationary frame 120 for selective interaction with the movable frame 130 and/or the outer frame 110 (as shown in FIG. 2b,) and a seal 144 may extend across or around the movable frame 130 for selective interaction with the stationary frame 120 and/or the outer frame 110 (as shown in FIG. 3b). The seals 142, 144 may or may not be compression seals.

A sensor 150 may be included in the outer frame 110 to detect a breach in the stationary frame 120 and/or the movable frame 130, as shown in FIGS. 1 and 5c. The sensor 150 may be, for example, a glass break sensor or a reed switch, and the sensor 150 may be in data communication with a local or remote alarm.

In use, the outer frame 110 is installed in a wall. The protrusions 124 may extend into the holes 112 to couple the stationary frame 120 to the outer frame 110. The protrusions 134 may extend into the channels 114 to couple the movable frame 130 to the outer frame 110. The protrusions may slide along the channels 114 to move the movable frame 130 between the outer frame first and second ends 110a, 110b, and the inclined portions 114b of the channels 114 may allow the movable frame 130 to be colinear with the stationary frame 120 when at the outer frame second end 110b as discussed above. The seals 140, 142, 144 keep air from passing between the outer frame 110 and the stationary frame 120, the outer frame 110 and the movable frame 130, and the stationary frame 120 and the movable frame 130 when the stationary frame 120 and the movable frame 130 are colinear. The sensor 150 adds security to the system, as it may detect a breach in the stationary frame 120 and/or the movable frame 130.

It is understood that while certain forms of this invention have been illustrated and described, it is not limited thereto except insofar as such limitations are included in the following claims and allowable functional equivalents thereof.

What is claimed is as follows:

1. A window system, comprising:
an outer frame having opposed first and second ends;
a stationary inner frame inside said outer frame at said outer frame first end; and
a movable inner frame positionable in said outer frame for movement between said outer frame second end and said outer frame first end, said movable frame and said stationary frame being colinear when said movable frame is at said outer frame second end and generally parallel when said movable frame is at said outer frame first end.

2. The window system of claim 1, wherein:
said outer frame has opposed third and fourth sides that are generally perpendicular to said first and second ends;
said third and fourth sides collectively define a first pair of opposed channels having a longitudinal portion and an inclined portion;
said third and fourth sides collectively define a second pair of opposed channels having a longitudinal portion and an inclined portion, said longitudinal portions of said first pair of opposed channels being colinear with said longitudinal portions of said second pair of opposed channels;
a first pair of protrusions extends from said movable inner frame into said first pair of channels to couple said movable frame to said outer frame;
a second pair of protrusions extends from said movable inner frame into said second pair of channels to couple said movable frame to said outer frame; and
said first and second pairs of protrusions are movable in said first and second pairs of channels to move said movable frame between said second end of said outer frame and said first end of said outer frame.

3. The window system of claim 2, wherein at least one said protrusion is extendable to lock said movable frame at a position in said outer frame.

4. The window system of claim 2, wherein:
said movable frame has a transparent section; and
said stationary frame has a transparent section.

5. The window system of claim 2, wherein:
said transparent section of said movable frame includes glass; and
said transparent section of said stationary frame includes glass.

6. The window system of claim 2, wherein said stationary frame has a section selected from the group consisting of an open section and a transparent section.

7. The window system of claim 1, wherein said movable frame has a transparent section having a plurality of panes separated by an insulator.

8. The window system of claim 7, wherein said insulator is gaseous.

9. The window system of claim 1, wherein:
a seal extends across said stationary frame for selective interaction with said movable frame; and
a seal extends across said movable frame for selective interaction with said outer frame.

10. The window system of claim 1, wherein:
a seal extends across one end of said movable frame for selective interaction with said stationary frame; and
a seal extends across another end of said movable frame for selective interaction with said outer frame.

11. The window system of claim 1, wherein said outer frame includes a sensor to detect a breach in at least one of said movable frame and said stationary frame.

12. A window system, comprising:
an outer frame having opposed top and bottom ends;
a stationary inner frame inside said outer frame at said outer frame top end, said stationary frame having top and bottom ends; and
a movable inner frame positionable in said outer frame for movement between said outer frame top and bottom ends, said movable frame having top and bottom ends, said movable frame top end being adjacent said stationary frame bottom end so that said movable frame and said stationary frame are colinear when said movable frame is at said outer frame bottom end, said movable frame and said stationary frame being generally parallel when said movable frame is at said outer frame top end.

13. The window system of claim 12, wherein:
said outer frame has opposed third and fourth sides that are generally perpendicular to said outer frame top and bottom ends;
said third and fourth sides collectively define a first pair of opposed channels having a longitudinal portion and an inclined portion;
a first pair of protrusions extends from said movable inner frame into said first pair of channels to couple said movable frame to said outer frame; and
said first pair of protrusions is movable in said first pair of channels to move said movable frame between said bottom and top ends of said outer frame.

14. The window system of claim 13, wherein:
said third and fourth sides collectively define a second pair of opposed channels having a longitudinal portion and an inclined portion, said longitudinal portions of said first pair of opposed channels being colinear with said longitudinal portions of said second pair of opposed channels;
a second pair of protrusions extends from said movable inner frame into said second pair of channels to couple said movable frame to said outer frame; and
said second pair of protrusions is movable in said second pair of channels to move said movable frame between said bottom and top ends of said outer frame.

15. The window system of claim 14, wherein said outer frame includes a sensor to detect a breach in at least one of said movable frame and said stationary frame.

16. The window system of claim 13, wherein said outer frame includes a compression seal for interaction with said movable frame when said movable frame is at said outer frame bottom end.

17. The window system of claim 13, where a compression seal surrounds said movable frame.

18. The window system of claim 12, wherein said stationary frame bottom end has a depth that is angled relative to the horizon and said movable frame top end has a depth that is angled complementary to said angled depth of said stationary frame bottom end.

19. The window system of claim 12, wherein said stationary frame has a section selected from the group consisting of an open section and a transparent section.

20. The window system of claim 12, wherein said outer frame includes a sensor to detect a breach in at least one of said movable frame and said stationary frame.
